(19) United States
(12) Patent Application Publication
(10) Pub. No.: US 2012/0329898 A1
(43) Pub. Date: Dec. 27, 2012

(54) 2-OCTYL (METH)ACRYLATE ADHESIVE COMPOSITION

(75) Inventors: Arlin L. Weikel, Roberts, WI (US); Jayshree Seth, Woodbury, MN (US); Maureen A. Kavanagh, Stanchfield, MN (US); Cordell M. Hardy, Woodbury, MN (US); John W. Frank, Cottage Grove, MN (US); Chi-Ming Tseng, Woodbury, MN (US)

(73) Assignee: 3M Innovative Properties Company

(21) Appl. No.: 13/565,210

(22) Filed: Aug. 2, 2012

Related U.S. Application Data
(63) Continuation-in-part of application No. 12/337,185, filed on Dec. 17, 2008.
(60) Provisional application No. 61/044,748, filed on Apr. 14, 2008.

(51) Int. Cl. C09J 133/08; C08K 7/28; C08K 3/36; C08F 222/14; C08K 3/02

(52) U.S. Cl. 522/33; 526/318.4; 524/560; 524/428; 525/55; 523/219

(57) ABSTRACT

A pressure sensitive adhesive composition comprising a 2-octyl(meth)acrylate, (meth)acrylic acid copolymer and optional crosslinking agents is described. The adhesive composition may be derived from renewable resources and provides good peel, shear and high temperature stability.

This application is a continuation-in-part of U.S. Ser. No. 12/337,185, filed Dec. 17, 2008, which claims the benefit of Provisional Application No. 61/044,748, filed Apr. 14, 2008, the disclosures of which are herein incorporated by reference.

### BACKGROUND

Pressure sensitive adhesives (PSAs) are well known in the art. Available PSAs are single or multilayer constructions, where the pressure sensitive adhesive composition is often chosen from acrylic polymers. Pressure sensitive adhesives are known that possess properties including the following: (1) aggressive and permanent tack, (2) adherence with no more than finger pressure, (3) sufficient ability to hold onto an adherend or substrate, and (4) sufficient cohesive strength to be removed cleanly from the adherend. Materials, such as acrylics, that have been found to function well as PSAs include polymers designed and formulated to exhibit the requisite viscoelastic properties resulting in a desired balance of tack, peel adhesion, and shear holding power. PSAs are characterized by being normally tacky at room temperature (e.g., 20° C.). PSAs do not encompass compositions merely because they are sticky or adhere to a surface.

Foam-containing pressure-sensitive adhesive tapes are widely used for mounting objects such as pictures on walls or plastic body side molding on automobiles. Such tapes typically consist of a polyurethane, polychloroprene, acrylate or polyethylene foam carrying a layer of pressure-sensitive adhesive on each major surface. For other uses, the adhesive layer may cover only one major surface, e.g., a tape useful as a cushioning gasket for an automobile window. In some cases, the foam itself may be a PSA.

Only a limited number of classes of polymers have been found to function as PSAs. Among these polymer classes are natural and synthetic rubbers, (meth)acrylic polymers, silicones, block copolymers and olefins. Acrylic polymers have proven especially useful. Acrylic based PSAs are frequently prepared from isooctyl acrylate or 2-ethylhexyl acrylate. These adhesives have many desirable attributes such as high peel adhesion when applied to a wide variety of surfaces.

Acrylic PSAs are generally derived from petroleum feedstocks. The increase in the price of oil, and concomitant petroleum-derived products, has led to volatile prices and supply for many adhesive products. It is desirable to replace all or part of the petroleum-based feedstocks with those derived from renewable sources, such as plants, as such materials become relatively cheaper, and are therefore both economically and socially beneficial. Therefore, the need for such plant-derived materials has become increasingly significant.

In EP 0 728 166 B2, an acrylic-based pressure sensitive adhesive film is described. The film described therein comprises inorganic filler materials like silica particles, such as for example fumed silica. These particles are described to fulfill different functions in the adhesive tape. Firstly, the silica micro particles are described to improve the physical characteristics of the tape by an interlocking between said particles. Moreover, fumed silica is a less expensive ingredient compared to the organic polymers used in the adhesive tape. As a consequence, the costs of such an adhesive tape can be reduced by the introduction of such inorganic filler materials. Furthermore, the specific weight of the film is reduced by the filler thanks to the low density of silica compared to the polymer matrix.

Besides silica particles, other filler materials have been used in pressure sensitive adhesive films known in the art. EP 0 963 421 B1 describes the use of glass beads or glass bubbles as well as glass or ceramic fibers as filler materials in order to reduce the weight or the costs of the adhesive composition, to adjust its viscosity and to provide additional reinforcement. Typical amounts of these fillers are given in the range from 0 to 50 wt % with respect to the total mass of the other components.

There is still a need for PSA films having improved adhesion characteristics. There is also a need for PSA films made using feed stocks available from renewable sources.

### SUMMARY

The present disclosure provides a pressure sensitive adhesive composition and articles made there from that have improved adhesion characteristics. In one aspect, the present disclosure provides an adhesive composition comprising a copolymer which is the reaction product of: 2-octyl(meth)acrylate; 0.5 to 20 wt % of a (meth)acrylic acid comonomer; and optionally other monomers, where the adhesive composition is a cellular pressure-sensitive adhesive comprising less than 15% voids. The term “(meth)acrylic” is understood to mean either methacrylic acid or acrylic acid. In some embodiments, the adhesive composition further comprises a photoinitiator.

In some embodiments, the adhesive composition comprises 80 wt % or greater of 2-octyl(meth)acrylate. In some embodiments, the adhesive composition comprises 85 wt % or greater of 2-octyl(meth)acrylate. In some embodiments, the adhesive composition comprises 0.5 to 15 wt % of a (meth)acrylic acid comonomer. In some embodiments, the adhesive composition comprises 10 to 15 wt % of a (meth)acrylic acid comonomer. In some embodiments, the adhesive composition comprises 80 wt % or greater of 2-octyl (meth)acrylate and 10 to 20 wt % of a (meth)acrylic acid comonomer. In some embodiments, the adhesive composition comprises 85 wt % or greater of 2-octyl(meth)acrylate and 10 to 15 wt % of a (meth)acrylic acid comonomer.

In some embodiments, the adhesive composition further comprises a crosslinker. In some embodiments, the adhesive composition further comprises glass bubbles. In some embodiments, the adhesive composition further comprises surfactant. In some embodiments, the adhesive composition further comprises silica. In some embodiments, the adhesive composition further comprises inert gas. In some embodiments, the adhesive composition further comprises nitrogen. In some embodiments, the adhesive composition further comprises glass bubbles, surfactant, silica, and nitrogen.

In some embodiments, the 2-octyl(meth)acrylate is the reaction product of 2-octyl alcohol with acrylic acid, wherein the 2-octyl alcohol has a ¹⁴C/C ratio of 1.0×10⁻¹⁴ or higher. In some embodiments, the other monomers include monomers selected from the group of primary octyl acrylates.

In another aspect, the present disclosure provides a multilayer adhesive article comprising any of these embodiments of adhesive compositions.

### DETAILED DESCRIPTION

The adhesive composition comprises a copolymer comprising:
1) 2-octyl(meth)acrylate;
2) carboxylic acid functional comonomer; and
3) optionally other monomers,
wherein the adhesive composition is a cellular pressure-sensitive adhesive composition comprising less than 15% voids.

The 2-octyl(meth)acrylate may be prepared by conventional techniques from 2-octanol and (meth)acryloyl derivatives such as esters, acids, and acyl halides. The 2-octanol may be prepared by treatment of ricinoleic acid, derived from castor oil, (or ester or acyl halide thereof) with sodium hydroxide, followed by distillation from the co-product sebacic acid.

In some embodiments, the polymerizable precursor of the polymer base material is at least partly derived from biological material, preferably from a plant material. More preferably, at least 25 wt % of the polymerizable precursor of the polymer base material is derived from biological material, more preferably at least 40 wt % of the polymerizable precursor of the polymer base material is derived from biological material. This may advantageously be used to provide adhesive films/tapes which are at least partly derived from “green” sources, which is ecologically more sustainable and also reduces the dependency on petroleum based products and its ever-changing price.

In the context of the present disclosure, the term “derived from biological material” is meant to express that for a certain chemical ingredient, at least a part of its chemical structure comes from biological materials, preferably at least 50 wt % of its structure. This definition is in principle the same as for bio-diesel fuel, in which usually only the fatty acid part originates from biological sources whereas the methanol may also be derived from fossil material like coal or mineral oil. In some embodiments, when the PSA film comprises 2-octyl(meth)acrylate, it is preferred that the 2-octyl(meth)acrylate is completely (i.e. 100 wt %) derived from biological material.

Examples of other monomers that may be co-polymerized with the (meth)acrylate ester and carboxylic acid-functional monomers include C₁-C₁₀ (meth)acrylates such as methyl (meth)acrylate, cyclohexyl(meth)acrylate, butyl (meth)acrylates, phenyl(meth)acrylate, primary octyl acrylates such as 2-ethylhexyl acrylate and 6-methylheptyl(meth)acrylate; further examples include N-vinyl pyrrolidone, (meth)acrylamides, alpha-olefins, vinyl ethers, allyl ethers, styrene and other aromatic vinyl compounds, maleic acid esters, 2-hydroxyethyl (meth)acrylate, N-vinyl caprolactam, and substituted (meth)acrylamides such as N-ethyl (meth)acrylamide, N-hydroxyethyl (meth)acrylamide, N-octyl(meth)acrylamide, N-t-butyl (meth)acrylamide, N,N-dimethyl (meth)acrylamide, N,N-diethyl (meth)acrylamide, and N-ethyl-N-dihydroxyethyl (meth)acrylamide.

One or more alkyl acrylates of the polymerizable composition are typically mono-functional monomers and include in particular acrylic acid ester of a nontertiary alcohol in which the alkyl group contains at least about 3 carbon atoms (on average), and preferably about 4 to about 14 carbon atoms (on average). Typically, the homopolymers of such monomers have a Tg of no greater than about 0° C. Examples of classes of suitable acrylic acid esters include, but are not limited to, 2-methylbutyl acrylate, 2-ethylhexyl acrylate, isooctyl acrylate, lauryl acrylate, n-decyl acrylate, 4-methyl-2-pentyl acrylate, isoamyl acrylate, sec-butyl acrylate, and isononyl acrylate. Preferred acrylic acid esters that can be used include, but are not limited to, 2-ethylhexyl acrylate, isooctyl acrylate, lauryl acrylate, and 2-methylbutyl acrylate. Various combinations of such monomers can be employed. For example, a combination of two or more alkyl acrylates may be used such as a combination of 2-ethylhexyl acrylate and isooctyl acrylate.

The polymerizable composition further includes one or more polar monomers, typically monofunctional polar monomers. Examples thereof include in particular acidic monomers such as carboxylic acid monomers as well as various acrylamides. Particular examples of polar monomers include acrylic acid, methacrylic acid, itaconic acid, maleic acid, fumaric acid, N-vinyl pyrrolidone, N-vinyl caprolactam, acrylamide, methacrylamide, N-substituted and N,N-disubstituted acrylamides such as N-ethyl acrylamide, N-hydroxyethyl acrylamide, N,N-dimethyl acrylamide, N,N-diethyl acrylamide, and N-ethyl, N-dihydroxyethyl acrylamide, and maleic anhydride. Preferred polar monomers include, but are not limited to, acrylic acid, itaconic acid, N,N-dimethyl acrylamide, acrylamide, N-vinyl pyrrolidone and N-vinyl caprolactam. Various combinations of such polar monomers can be employed and in a particular embodiment a combination of two or more polar monomers is contemplated such as for example a combination of acrylic acid and itaconic acid.

The adhesive article comprises a foam layer having an acrylic polymer obtainable by polymerization of a polymerizable composition comprising one or more alkyl acrylates having an average of 3 to 14 carbon atoms in the alkyl group, one or more polar monomers and one or more multi-functional monomers having at least two free radical polymerizable groups. Examples of multi-functional monomers include in particular multi-functional acrylic monomers such as, for example, pentaerythritol tetraacrylate, tripropyleneglycoldiacrylate, and 1,12-dodecanediol diacrylate. Particular preferred examples of multi-functional acrylic monomers include 1,2 ethylene glycol diacrylate, hexanediol diacrylate and trimethylol propane triacrylate. The amount of multi-functional monomer or monomers in the polymerizable composition is typically at least 0.01% by weight and may range for example from 0.01% by weight to 1% or less by weight, and is some embodiments from 0.1 to 0.5% by weight of the total weight of monomers in the composition.

In order to increase cohesive strength of the poly(meth)acrylate pressure sensitive adhesives, an optional crosslinking agent may be incorporated into the adhesive composition. Chemical crosslinkers, which rely upon free radicals to carry out the crosslinking reaction, may be employed. Reagents such as, for example, peroxides serve as a source of free radicals. When heated sufficiently, these precursors will generate free radicals which bring about a crosslinking reaction of the polymer. A common free radical generating reagent is benzoyl peroxide. Free radical generators are required only in small quantities, but generally require higher temperatures to complete a crosslinking reaction than those required for the bisamide and isocyanate reagents.

Other useful chemical crosslinkers include polyisocyanates such as aliphatic, alicyclic, and aromatic diisocyanates, and mixtures thereof. A number of such diisocyanates are commercially available. Representative examples of suitable diisocyanates include hexamethylene diisocyanate (HDMI), trimethyl hexamethylene diisocyanate (TMHDI), m- and p-tetramethylxylene diisocyanate (TMXDI), diphenylmethane diisocyanate (MDI), napthalene diisocyanate (NDI), phenylene diisocyanate, isophorone diisocyanate (IPDI), toluene diisocyanate (TDI), bis(4-isocyanatocyclohexyl) methane (H₁₂MDI), and the like, and mixtures thereof. Useful polyisocyanates also include derivatives of the above-listed monomeric polyisocyanates. These derivatives include, but are not limited to, polyisocyanates containing biuret groups, such as the biuret adduct of hexamethylene diisocyanate (HDMI) available from Bayer Corp., Pittsburgh, Pa. under the trade designation DESMODUR N-100, polyisocyanates containing isocyanurate groups, such as that available from Bayer Corp., Pittsburgh, Pa. under the trade designation DESMODUR N-3300, as well as polyisocyanates containing urethane groups, uretdione groups, carbodiimide groups, allophonate groups, and the like. If desired, small amounts of one or more polyisocyanates having three or more isocyanate groups can be added to effect a degree of crosslinking. Preferred polyisocyanates include aliphatic diisocyanates and derivatives thereof, with IPDI being most preferred.

The second type of crosslinking additive is a photosensitive crosslinker, which is activated by high intensity ultraviolet (UV) light. Two common photosensitive crosslinkers used for (meth)acrylic PSAs are benzophenone and copolymerizable aromatic ketone monomers as described in U.S. Pat. No. 4,737,559 (Kellen et al.). Another type of photosensitive crosslinker includes multi-functional compounds such as 1,2 ethylene glycol diacrylate, hexanediol diacrylate and trimethylol propane triacrylate. Another photocrosslinker, which can be post-added and activated by UV light is a triazine, for example, 2,4-bis(trichloromethyl)-6-(4-methoxy-phenyl)-s-triazine. These crosslinkers are activated by UV light generated from sources such as medium pressure mercury lamps or a UV blacklight.

Hydrolyzable, free-radically copolymerizable crosslinkers, such as monoethylenically unsaturated mono-, di-, and trialkoxy silane compounds including, but not limited to, methacryloxypropyltrimethoxysilane (available from Gelest, Inc., Tullytown, Pa.), vinyl dimethylethoxysilane, vinyl methyl diethoxysilane, vinyltriethoxysilane, vinyltrimethoxysilane, vinyltriphenoxysilane, and the like, are also useful crosslinking agents. Crosslinking may also be achieved using high energy electromagnetic radiation such as gamma or e-beam radiation. In this case, no crosslinker may be required.

The acrylic polymer of the foam layer is typically obtainable from a polymerizable composition having a major amount of the one or more alkyl acrylates, for example at least 80% by weight (based on the total weight of monomers in the composition). A typical range is from 80 to 97% by weight, 84 to 97% by weight or from 88 to 94% by weight. In addition to the major amount of the one or more alkyl acrylates, in some embodiments, the presently disclosed polymerizable composition includes at least one polar comonomer, such as a meth(acrylic) acid comonomer. The polar comonomer is present in the amount of 0.5 wt % to 15 wt %, in some embodiments 10 wt % to 20 wt %, and in some embodiments 10 wt % to 20 wt % (based on the total weight of monomers in the composition). The polar monomer or monomers are typically present in amount of at least 3% by weight of the total weight of monomers in the composition, an exemplary range being from 3 to 16% or from 5 to 12% by weight.

The polymerizable composition may contain further components including in particular a thixotropic agent. Examples of thixotropic agents include silica. The polymerizable composition may also contain microspheres such as for example hollow glass bubbles or polymeric microspheres. Furthermore, it may be desirable to include a surfactant in the polymerizable composition. In some embodiments, the polymerizable composition includes combinations of thixotropic agents and surfactants, and the like. In some embodiments, the polymerizable composition includes glass bubbles, silica, surfactant, and combinations thereof. Tackifiers, in particular tackifiers suitable for use with acrylic adhesives may be added as well. Examples thereof include in particular rosin esters, aromatic resins, aliphatic resins, terpenes and partially hydrogenated and hydrogenated resins.

In the practice of the invention, the copolymers can be polymerized by techniques including, but not limited to, the conventional techniques of solvent polymerization, emulsion polymerization, solventless bulk polymerization, and radiation polymerization, including processes using ultraviolet light, electron beam, and gamma radiation. The monomer mixture may comprise a polymerization initiator, especially a thermal initiator or a photoinitiator of a type and in an amount effective to polymerize the comonomers.

In some embodiments, photoinitiators may be used in connection with this disclosure. Examples of initiators can be found in U.S. Pat. Nos. 4,181,752 (Martens et al.), 4,833,179 (Young et al.), 5,804,610 (Hamer et al.), 5,382,451 (Johnson et al.), 4,619,979 (Kotnour et al.), 4,843,134 (Kotnour et al.), and 5,637,646 (Ellis).

Suitable thermal initiators include but are not limited to azo compounds such as VAZO 64 (2,2′-azobis-(isobutyronitrile)), VAZO 52 (2,2′-azobis-(2,4-dimethylpentanenitrile)), and VAZO 67 (2,2′-azobis-(2-methylbutyronitrile)) available from E.I. du Pont de Nemours Co., peroxides such as benzoyl peroxide and lauroyl peroxide, and mixtures thereof. An exemplary oil-soluble thermal initiator is (2,2′-azobis-(2-methylbutyronitrile)).

In a typical photopolymerization method, a monomer mixture may be irradiated with ultraviolet (UV) rays in the presence of a photopolymerization initiator (i.e., photoinitiators). Useful photoinitiators are those available under the trade designations IRGACURE and DAROCUR from Ciba Speciality Chemical Corp., Tarrytown, N.Y. and include 1-hydroxy cyclohexyl phenyl ketone (IRGACURE 184), 2,2-dimethoxy-1,2-diphenylethan-1-one (IRGACURE 651), bis(2,4,6-trimethylbenzoyl)phenylphosphineoxide (IRGACURE 819), 1-[4-(2-hydroxyethoxy)phenyl]-2-hydroxy-2-methyl-1-propane-1-one (IRGACURE 2959), 2-benzyl-2-dimethylamino-1-(4-morpholinophenyl)butanone (IRGACURE 369), 2-methyl-1-[4-(methylthio)phenyl]-2-morpholinopropan-1-one (IRGACURE 907), and 2-hydroxy-2-methyl-1-phenyl propan-1-one (DAROCUR 1173). In some embodiments, photoinitiators are selected from IRGACURE 819, 184 and 2959.

Initiators useful in preparing the (meth)acrylate adhesive polymers used in the present invention are initiators that, on exposure to heat or light, generate free-radicals which initiate (co)polymerization of the monomer mixture. These initiators can be employed in concentrations ranging from about 0.0001 to about 3.0 pbw, from about 0.001 to about 1.0 pbw, or from-about 0.005 to about 0.5 pbw, per 100 pbw of the monomer composition.

The adhesive product of the present invention may be made by the steps of:

(1) frothing a composition which is polymerizable to
a pressure-sensitive adhesive state,
(2) coating the froth onto a backing, and
(3) polymerizing the coated froth in situ to a pressure sensitive adhesive state
to provide a pressure-sensitive adhesive membrane having a cellular structure comprising less than 15% voids.

Alternatively, the composition can be coated onto the backing without first being frothed, and the cellular pressure sensitive adhesive obtained by simultaneously frothing and polymerizing the coating.

In a solventless polymerization method, the pressure sensitive adhesives of the present invention are prepared by photoinitiated polymerization methods according to the technique described in U.S. Pat. No. 4,181,752, hereby incorporated by reference. For example, into a mixture of photopolymerizable monomers can be added a photoinitiator and the resulting mixture partially polymerized to provide a syrup about 3000 cps in viscosity by exposure to ultraviolet radiation. A second charge of photoinitiator can be added to the syrup along with any other additional components to be used and the blend slowly mixed with an air motor, taking care not to cause any frothing. Next, the mixture can be transferred to a frother. While feeding nitrogen gas into the frother, the frothed syrup can be delivered to the nip of a roll coater between a pair of transparent, biaxially-oriented polyethylene terephthalate films, the facing surfaces of which have been provided with low-adhesion coatings.

Other additives can be included in the polymerizable mixture or added at the time of compounding or coating to change the properties of the pressure sensitive adhesive. Such additives, include pigments, tackifiers, fillers such as glass or polymeric bubbles or beads (which may be expanded or unexpanded), hydrophobic or hydrophilic silica, calcium carbonate, glass or synthetic fibers, blowing agents, toughening agents, reinforcing agents, fire retardants, antioxidants, and stabilizers. Hollow glass microspheres having an average diameter of 10 to 200 micrometers can be blended into the polymerizable composition prior to coating, thus producing additional beneficial results as taught in U.S. Pat. No. 4,223,067 (Levens). The hollow spaces within the microsphere are not taken into account when calculating the voids of a cellular pressure sensitive adhesive.

$$\% Voids = \{ \frac{d u - d f}{d u} \} * 100 ,$$

where du is the density of unfrothed and df is density of frothed material.

The additives are added in amounts sufficient to obtain the desired end properties. The composite that emerges from the roll coater can then be irradiated with a bank of fluorescent black light bulbs having 90% of its emissions between 300 and 400 nm with a maximum at 351 nm. An exemplary exposure would be 900 milli-Joules as measured by an International Light “Light Bug” which is spectrally responsive between 250 and 430 nm, maximum 350 nm. The composite may be cooled by blowing air against both films during the irradiation to keep the temperature of the films below 85 C to avoid wrinkling of the films. The uniformity, density, cell size, tensile strength and elongation of cellular pressure sensitive adhesive of the resultant tape are all affected by the selection and amount of surfactant, the nitrogen flow rate, and the pressure in the frother.

The resulting composition is coated onto a substrate (which may be transparent to ultraviolet radiation) and polymerized in an inert (i.e., oxygen free) atmosphere, e.g., a nitrogen atmosphere, by exposure to ultraviolet radiation. Examples of suitable substrates include release liners (e.g., silicone release liners) and tape backings, which may be primed or unprimed paper or plastic. A sufficiently inert atmosphere can also be achieved by covering a layer of the polymerizable coating with a plastic film which is substantially transparent to ultraviolet radiation, and irradiating through that film in air as described in the aforementioned patent using ultraviolet lamps. Alternatively, instead of covering the polymerizable coating, an oxidizable tin compound may be added to the polymerizable syrup to increase the tolerance of the syrup to oxygen as described in U.S. Pat. No. 4,303,485. The ultraviolet light source preferably has 90% of its emissions between 280 and 400 nm (or between 300 and 400 nm), with a maximum at 351 nm.

The pressure sensitive adhesive composition can be applied to any suitable substrate such as a sheet, a fiber, or a shaped article. However, the preferred substrates are those used for pressure sensitive adhesive products.

The present invention further provides adhesive articles comprising the cured adhesive composition disposed on a backing or suitable substrate. In addition to a variety of traditional pressure sensitive adhesive articles, such as tapes, labels, decals, transfer tapes and other articles the pressure sensitive adhesive article can be used in decorative, light management and optical articles.

Suitable materials useful as the flexible support or backing for the adhesive articles of the invention include, but are not limited to, polyolefins such as polyethylene, polypropylene (including isotactic polypropylene), polystyrene, polyester, including poly(ethylene terephthalate), polyvinyl chloride, poly(butylene terephthalate), poly(caprolactam), polyvinyl alcohol, polyurethane, poly(vinylidene fluoride), cellulose and cellulose derivatives such as cellulose acetate and cellophane, and the like. Commercially available backing materials useful in the invention include kraft paper (available from Monadnock Paper, Inc.); spun-bond poly(ethylene) and poly(propylene), such as Tyvek™ and Typar™ (available from DuPont, Inc.); and porous films obtained from poly(ethylene) and poly(propylene), such as Teslin™ (available from PPG Industries, Inc.), and Cellguard™ (available from Hoechst-Celanese).

Typical examples of flexible backing materials employed as conventional tape backing that may be useful for the adhesive compositions include those made of paper, plastic films such as polypropylene, polyethylene, polyester (e.g., polyethylene terephthalate, polyimide, or poly(lactic acid)), cellulose acetate, ethyl cellulose, their copolymers and their derivatives. Films comprised of polymer blends or of multiple film layers may be used. Backings may also be prepared of fabric such as woven fabric formed of threads of synthetic or natural materials such as cotton, nylon, rayon, glass, ceramic materials, and the like or nonwoven fabric such as air laid webs of natural or synthetic fibers or blends of these. The backing may also be formed of metal, metallized polymer films, or ceramic sheet materials and may take the form of any article conventionally known to be utilized with pressure sensitive adhesive compositions such as labels, tapes, signs, covers, marking indicia, and the like.

The above-described adhesive compositions are coated on a substrate using conventional coating techniques modified as appropriate to the particular substrate. For example, these compositions can be applied to a variety of solid substrates by methods such as roll, brush coating, flow, dip, spin, spray, knife, spread, wire, gravure, doctor blade and die coating. These various methods of coating allow the compositions to be placed on the substrate at various thicknesses thus allowing a wider range of use of the compositions.

The coating thickness will depend upon various factors such as, for example, the particular application, the coating formulation, and the nature of the substrate (e.g., its absorbency, porosity, surface roughness, crepe, chemical composition, etc.). Coating thicknesses of 2-2500 micrometers (dry thickness), or 10 to 1250 micrometers, are contemplated.

The flexible support or backing may also comprise a release-coated substrate. Such substrates are typically employed when an adhesive transfer tape is provided. Examples of release-coated substrates are well known in the art. They include, by way of example, silicone-coated kraft paper and the like. Tapes of the invention may also incorporate a low adhesion backsize (LAB) and/or a primer. Typically the primer is applied to the same tape backing surface as the adhesive, prior to adhesive coating, while the LAB is applied to the tape backing surface that is opposite that bearing the pressure sensitive adhesive. LABs and primers are known in the art.

### EXAMPLES

These examples are merely for illustrative purposes only and are not meant to be limiting on the scope of the claims. All parts, percentages, ratios, etc. in the examples and the rest of the specification are by weight, unless noted otherwise. Solvents and other reagents used were obtained from Sigma-Aldrich Chemical Company; Milwaukee, Wis. unless otherwise noted.

Table of Abbreviations

| Abbreviation or | | |
|---|---|---|
| Trade Designation | Description | Manufacturer |
| 2-OA | 2-octyl acrylate | 3M |
| IOA | Isooctyl acrylate | 3M |
| AA | Acrylic acid | BASF |
| Speedcure BKL | 2,2-dimethoxy-2- | Aceto |
| | phenylacetophenone | |
| HDDA | 1,6-hexanediol | Sartomer |
| | diacrylate | |
| HDK H15 | Fumed Silica | Wacker Silicones |
| GB | K15 Glass Bubbles | 3M |

### Test Methods

### Peel Adhesion Test [ASTM D 3330/D 3330M-04]

Four 1.0 inch (2.54 cm) by 3.0 inch (7.62 cm) strips of adhesive were laminated to a 5 mil (127 micrometers)aluminum foil backing for testing and were adhered to a stainless steel substrate by rolling twice in each direction with a 6.8 kg roller onto the tape at 12 inches per minute (about 305 mm/min). The force required to peel the tape at 90° was measured after a 24 hour dwell at 25° C./50% humidity on an Instron (model number 4465). The measurements for the four tape samples were in ounces per inch with a platen speed of 12 inches per minute (about 305 mm/min) then averaged. Peel adhesion data was then normalized to Newtons/decimeter (N/dm) and recorded in Table 2 below.

### Shear Strength Test [ASTM D-3654/D 3654M 06, PSTC-107]

A 1.0 (2.54 cm) inch wide strip of 5.9 mil (about 150 micrometers) aluminum backing was adhered by its adhesive to a stainless steel substrate and cut down to leave a 1.0 inch (2.54 cm) by 0.5 inch (1.27 cm) square for 194° F. (90° C.) temperature shear testing. A weight of 6.8 kg was rolled twice in each direction over the adhered portion at 12 inches per minute (about 305 mm/min) and allowed to dwell for 24 hrs. A 750 g load was attached to the tape sample for testing. Each sample was suspended until failure and/or test terminated. The time to failure, as well as the mode of failure, was recorded. Samples were run in triplicate and averaged for the table 2 below.

### Examples 1-4 and Control C₁-C₄

A gallon (about 3785 mL) jar was charged with isooctyl acrylate (IOA) or 2-octyl acrylate (2OA), acrylic acid (AA), and 2,2-dimethoxy-2-phenylacetophenone photoinitiator (Speedcure BKL, 0.04 phr) as shown in Table 1. The monomer mixture was purged with nitrogen for 20 minutes then exposed to low intensity ultraviolet radiation until a coatable syrup copolymer was prepared, after which an additional 2,2-dimethoxy-2-phenylacetophenone photoinitiator (Speedcure BKL, 0.16 phr), HDK H15 fumed silica (1.7 phr), and 1,6-hexanediol diacrylate (HDDA, 0.55 phr) were sheared mixed at 4000 rpm until dispersed.

The pre-adhesive polymer syrup was then blended with K15 Glass Bubbles (8 phr). The syrup pre-adhesive formulations were then frothed as described in U.S. Pat. No. 4,415,615, using surfactant as described in U.S. Pat. No. 6,852,781 (Examples 44, 49-51) and pigment as described in U.S. Publication No. 2011-135922 (Example 15), and coated on polyester film at a 40 mil (about 305 micrometers) thickness and cured using UVA at a total dosage of 1490 mJ/cm².

For comparative purposes, control samples without frothing (Example C₁-C₄) were also prepared and tested.

Peel adhesion, shear strength, density, caliper and volatiles were measured for tapes prepared from pre-adhesive syrup as described in the test methods above and the data shown in Table 2.

TABLE 1

| Example | IOA (wt %) | 2-OA (wt %) | AA (wt %) |
|---|---|---|---|
| 1 | 87.5 | | 12.5 |
| 2 | 90 | | 10 |
| 3 | | 87.5 | 12.5 |
| 4 | | 90 | 10 |

TABLE 2

| | | 90 deg Peel Force | Shear | | | Volatile | |
|---|---|---|---|---|---|---|---|
| | Monomer | [N/cm] 24 | (min) | Density | Caliper | Content | % |
| Example | ratio | hr dwell | 70 C, 750 g | (kg/m³) | (mm) | (wt %) | Voids |
| C1 | IOA/AA | 21.0 | 528^{PO} | 724 | 0.963 | 1.2 | NA |
| | (87.5/12.5) | | | | | | |
| C2 | IOA/AA | 14.1 | 143^{PO} | 716 | 0.958 | 1.2 | NA |
| | (90/10) | | | | | | |
| C3 | 2-OA/AA | 28.8 | 2681^{PO} | 705 | 0.953 | 1.1 | NA |
| | (87.5/12.5) | | | | | | |
| C4 | 2-OA/AA | 12.4 | 5100^{PO} | 700 | 0.950 | 1.0 | NA |
| | (90/10) | | | | | | |
| 1 | IOA/AA | 19.4 | 10000 | 641 | 0.986 | 2.0 | 11.5 |
| | (87.5/12.5) | | | | | | |
| 2 | IOA/AA | 9.82 | 10000 | 638 | 0.968 | 2.3 | 10.9 |
| | (90/10) | | | | | | |
| 3 | 2-OA/AA | 25.2 | 10000 | 609 | 1.03 | 1.8 | 13.6 |
| | (87.5/12.5) | | | | | | |
| 4 | 2-OA/AA | 21.0 | 10000 | 634 | 0.960 | 1.8 | 9.43 |
| | (90/10) | | | | | | |

NA: not applicable
PO = pop-off failure mode
$\% Voids = \{ \frac{du - df}{du} \} * 100 ,$

where du is the density of unfrothed and df is density of frothed material. The hollow spaces within the glass microspheres are not taken into account when calculating the voids of a cellular pressure sensitive adhesive.

1. An adhesive composition comprising a copolymer which is the reaction product of:
1) 2-octyl(meth)acrylate;
2) 0.5 to 20 wt % of a (meth)acrylic acid comonomer; and
3) optionally other monomers, and wherein
the adhesive composition is a cellular pressure-sensitive adhesive.

2. The adhesive composition of claim 1 wherein the adhesive composition is a cellular pressure-sensitive adhesive composition comprising less than 15% voids.

3. The adhesive composition of claim 1 further comprising a photoinitiator.

4. The adhesive composition of claim 1, wherein the adhesive composition comprises 80 wt % or greater of 2-octyl(meth)acrylate.

5. The adhesive composition of claim 1, wherein the adhesive composition comprises 85 wt % or greater of 2-octyl(meth)acrylate.

6. The adhesive composition of claim 1, wherein the adhesive composition comprises 0.5 to 15 wt % of a (meth)acrylic acid comonomer.

7. The adhesive composition of claim 1, wherein the adhesive composition comprises 10 to 15 wt % of a (meth)acrylic acid comonomer.

8. The adhesive composition of claim 1, wherein the adhesive composition comprises 80 wt % or greater of 2-octyl(meth)acrylate and 10 to 20 wt % of a (meth)acrylic acid comonomer.

9. The adhesive composition of claim 1, wherein the adhesive composition comprises 85 wt % or greater of 2-octyl(meth)acrylate and 10 to 15 wt % of a (meth)acrylic acid comonomer.

10. The adhesive of claim 1 further comprising a crosslinker.

11. The adhesive composition of claim 1 further comprising glass bubbles.

12. The adhesive composition of claim 1 further comprising surfactant.

13. The adhesive composition of claim 1 further comprising silica.

14. The adhesive composition of claim 1 further comprising inert gas.

15. The adhesive composition of claim 1 further comprising nitrogen.

16. The adhesive composition of claim 1 further comprising glass bubbles, surfactant, silica, and nitrogen.

17. The adhesive composition of claim 1, wherein the 2-octyl(meth)acrylate is the reaction product of 2-octyl alcohol with acrylic acid, wherein the 2-octyl alcohol has a ¹⁴C/C ratio of 1.0×10⁻¹⁴ or higher.

18. The adhesive composition of claim 1, wherein the other monomers include monomers selected from the group of primary octyl acrylates.

19. A multilayer adhesive article comprising the adhesive composition of claim 1.
